(19) United States
(12) Patent Application Publication
(10) Pub. No.: US 2015/0134398 A1
(43) Pub. Date: May 14, 2015

(54) RISK DRIVEN PRODUCT DEVELOPMENT PROCESS SYSTEM

(71) Applicant: Jin Xing Xiao, San Diego, CA (US)

(72) Inventor: Jin Xing Xiao, San Diego, CA (US)

(21) Appl. No.: 14/075,947

(22) Filed: Nov. 8, 2013

(51) Int. Cl. G06Q 10/06

(52) U.S. Cl. CPC G06Q 10/0635
USPC 705/7.28

(57) ABSTRACT

New product developments are getting more and more risks due to the following uncertainties. The technology uncertainties are caused by the immaturity of components or system integration. The company-internal uncertainties are resulted from an inefficiency and unqualified Product Development Process (PDP). The customer requirement uncertainties are induced by levels of understanding of customer requirements or customer requirement changes. The market uncertainties are due to the actions of competitors or environmental influence.

In order to comfortably deal with above uncertainties, a new Risk driven Product Development Process (RPDP) is invented to facilitate new product developments. This method has phases of Product Plan, Product Design, Process Development, and Product Service which are communicated by FMEA tools. Within each phase, specific FMEA tools are dominated to manage potential risks and initiate mitigated actions if their risk levels are unacceptable. Particularly, a new FMEA Frisbee uses to determine the optimal mitigated actions. Once all potential risks are controlled under the acceptance levels, the process is flowed to the next phase.

The other new tools in this invention include Interaction Matrix, Integration Matrix, Spreadsheet of Market Requirement Analysis, and FMEAs Templates.

### BACKGROUND OF THE INVENTION

1. Field of the Invention

This invention relates to new product development process, and more specifically, relates to development for medical devices. The invention describes a new framework of product development processes mainly contributed by FDA Design Control Guidance (planning, input, designing, output, review, verification, validation, transfer, and change), Process Development (development, validation, transfer), Product Service, and risk management tools (FMEAs).

2. General Background of Invention

PDP (Product Development Process) is a complete process to bring a new product to market. In general, PDP has the functions of idea generation, idea screening, concept development and testing, business analysis, prototype testing, technical implementation, regulatory submission, clinical studies, and commercialization. An excellent PDP has a capability to develop a high quality product faster, less cost, and a greater profit.

In today's hyper-competitive global market, an excellent PDP is a crucial core competence and fundamental to the success of any consumer-driven companies. In fact, it argues that product development will become the dominant industry competence in the next decade (Morgan et al 2006).

Due to the growing complexity of modern products and changing markets, the challenge is that no a standardized PDP exists which can win the all. According to a recent study at Georgetown University's McDonough School of Business, at least half of all product launches fail to live up to companies' expectation. For every four projects that enter development, only one makes it to the market. Booz & Company found in an earlier study that about 70 percent of the resources spent on new launches are allocated to products that are not successful in the market (Jaruzelski 2011).

### SUMMARY OF THE INVENTION

The current invention provides a new product development method which is integrated by the design control guidance (ISO 13485, FDA Title 21 part 820), process development, and risk management. The new process consists of product plan phase, product design phase, process development phase, and product service phase.

Each phase is dominated by the specific risk management tools. System FMEA manages potential risks at product planning phase due to unclear customer requirements, immature new technologies, financial loss on non-critical product features, and less competitive. Design/Software FMEA manages potential risks at the product design phase due to design errors including out of tolerance, out of specification, wrong material data, against regulatory requirements, failed clinical studies, and lower reliability predication. Process FMEA manages potential risks at the process development phase due to undetailed manufacturing procedures, absent from sufficient quality controls, high process variation, untrained operators, missing system integration analysis, etc. Application FMEA manages potential risks at the product service phase due to wrong user operations, lack of sufficient usability studies, product failures in the life cycles, and environmental impacts.

Risk management tools (FMEAs) dominates the entire process from one phase to the next phase. Within each phase, mitigated actions are initiated if risk levels of failure modes are unacceptable. Otherwise, the product design and development activities shall be pushed into the following phase once risk levels of all potential failure modes are acceptable. Regarding individual failure mode, mitigated actions may be not only one and the optimal action is determined per the working efficiency.

### BRIEF DESCRIPTION OF THE DRAWINGS

A more complete understanding of the present inventions may be derived by referring to the detailed description and claims when considered in connection with the Figures, where like reference numbers refer to similar elements throughout the Figures, and:

FIG. 1 is a block diagram illustrating the RPDP framework integrated by Design Control Processes, Process Development, and FMEA tools at the top level view;

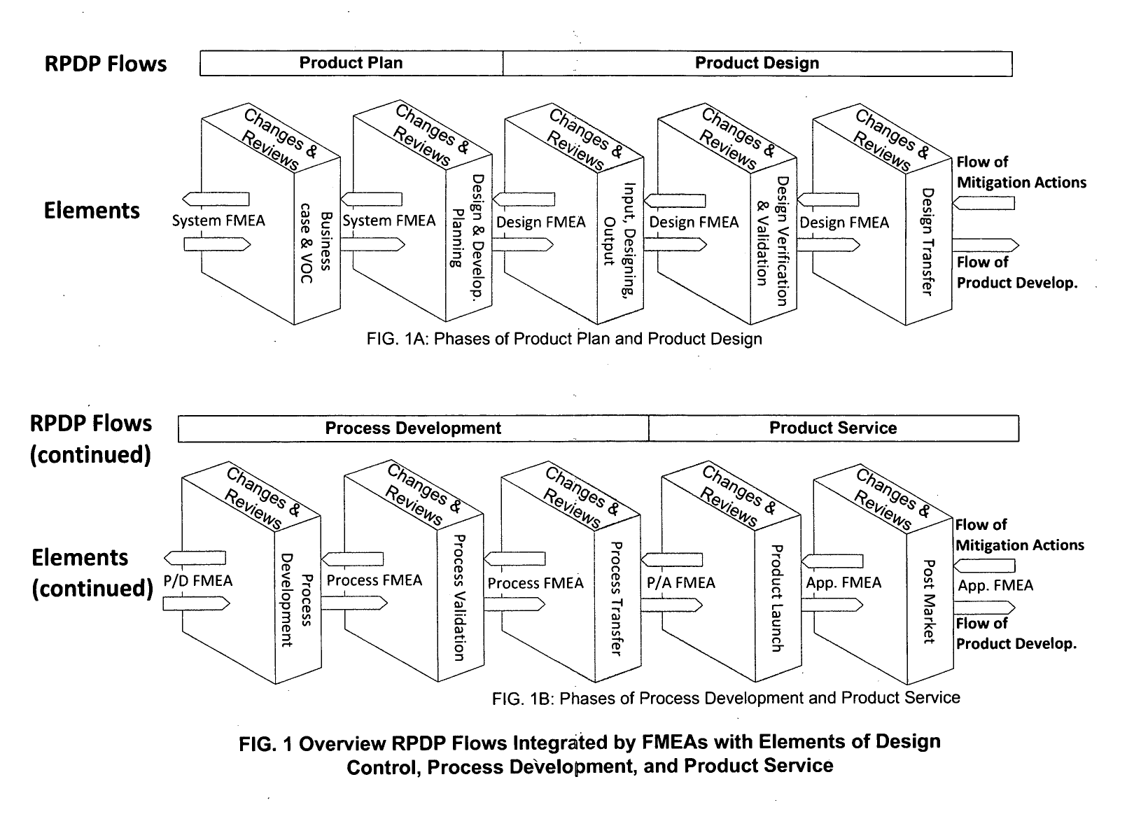

FIG. 2 is a block diagram illustrating the outputs of product planning phase which is dominated by the System FMEA;

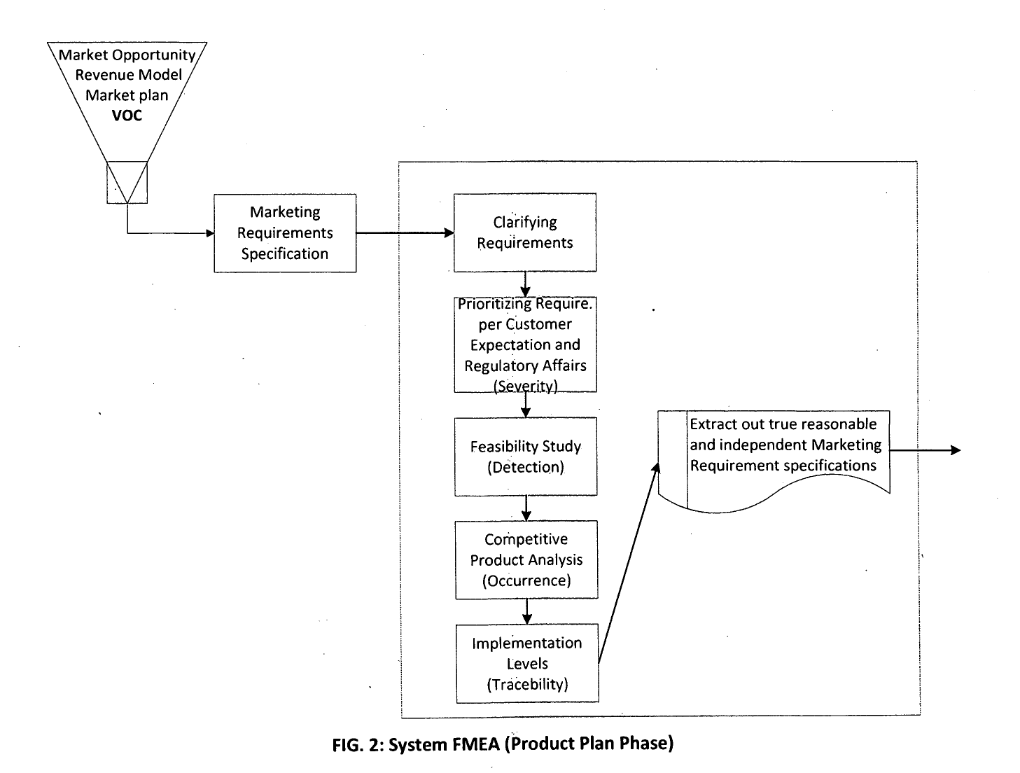

FIG. 3 is a block diagram illustrating the outputs of product design phase which is dominated by Design FMEA or Software FMEA (Top-down method);

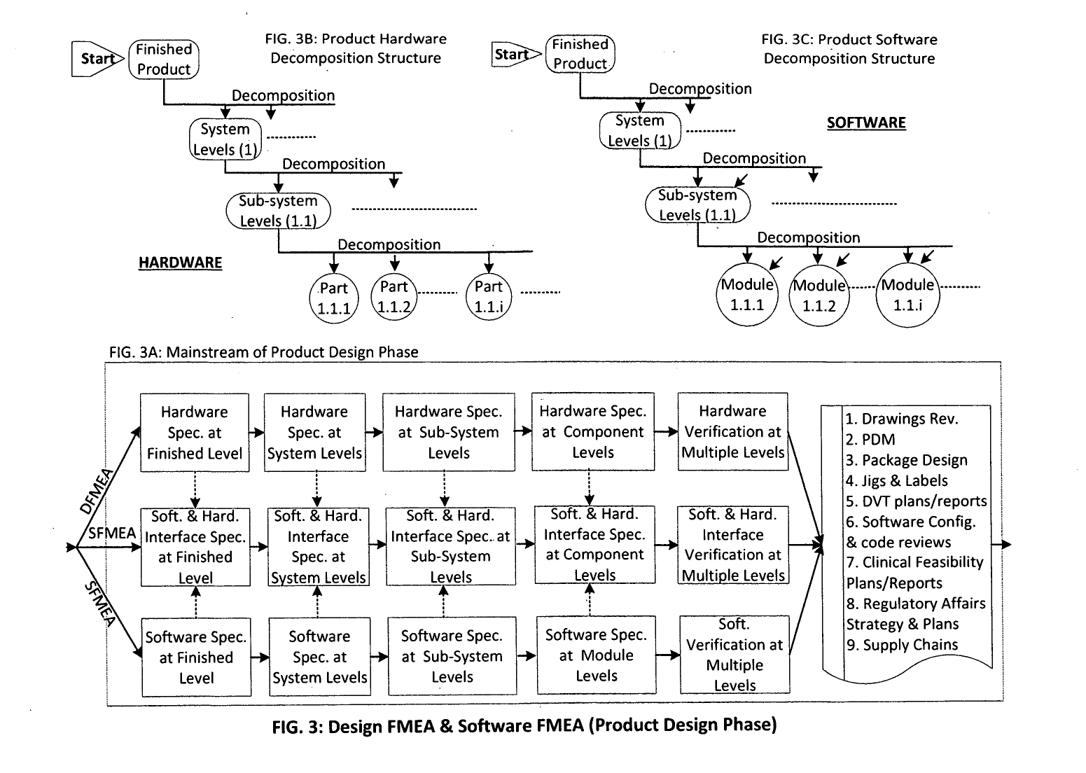

FIG. 4 is a block diagram illustrating the outputs of process development phase which is dominated by Process FMEA (Bottom-up method);

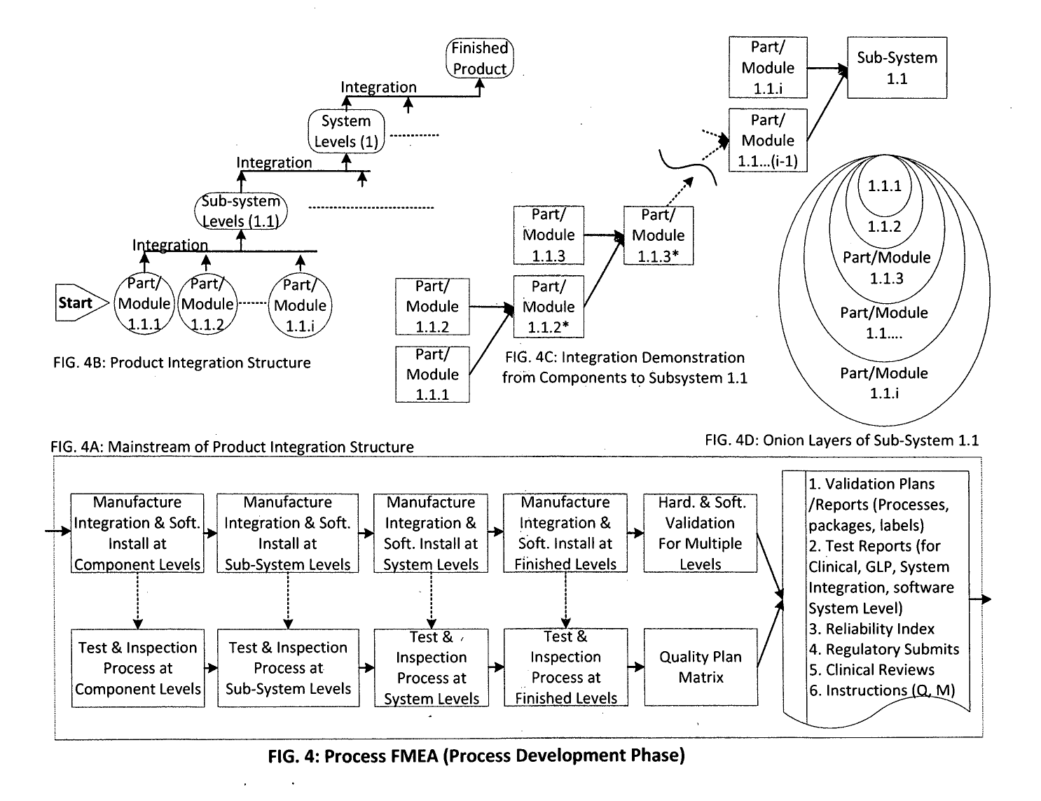

FIG. 5 is a block diagram illustrating the outputs of product service phase which is dominated by the Application FMEA;

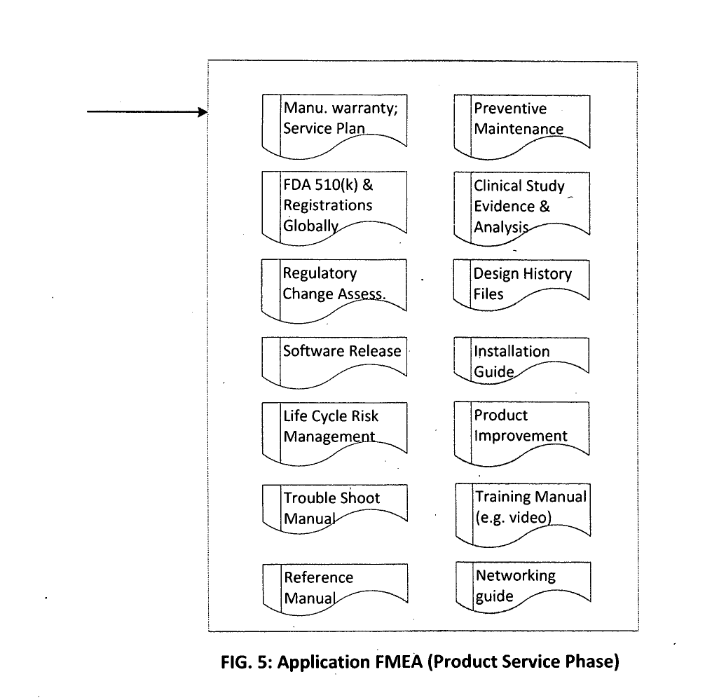

FIG. 6 is a spreadsheet to analyze interactions between product hardware components and product software modules and further identify the potential risks due to the interaction;

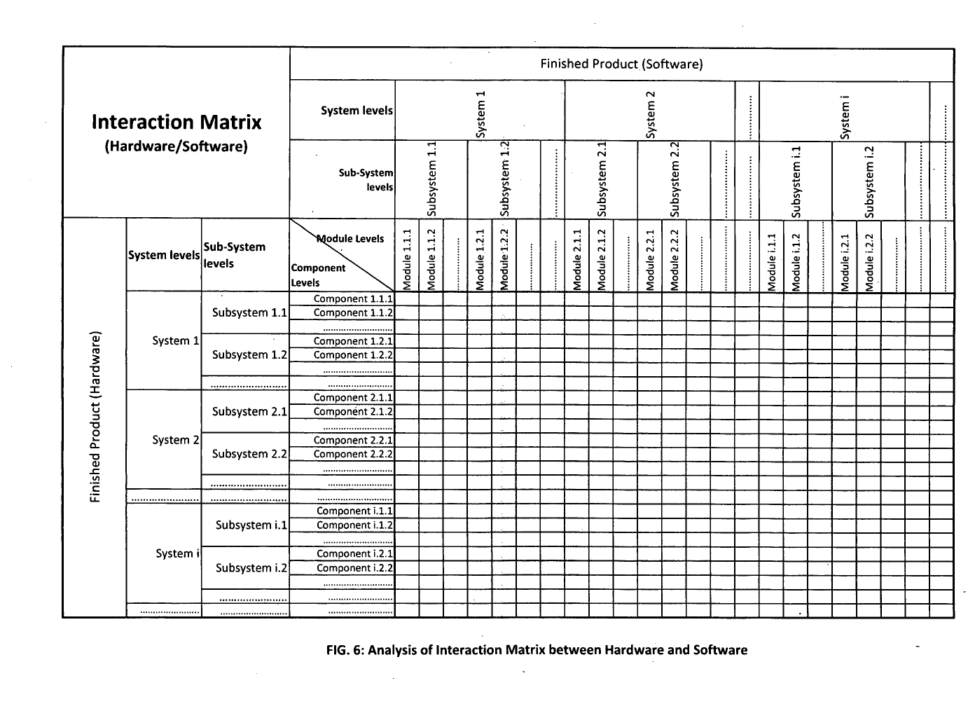

FIG. 7 is a spreadsheet to analyze product integrations at component levels and identify the potential risks due to the integrations;

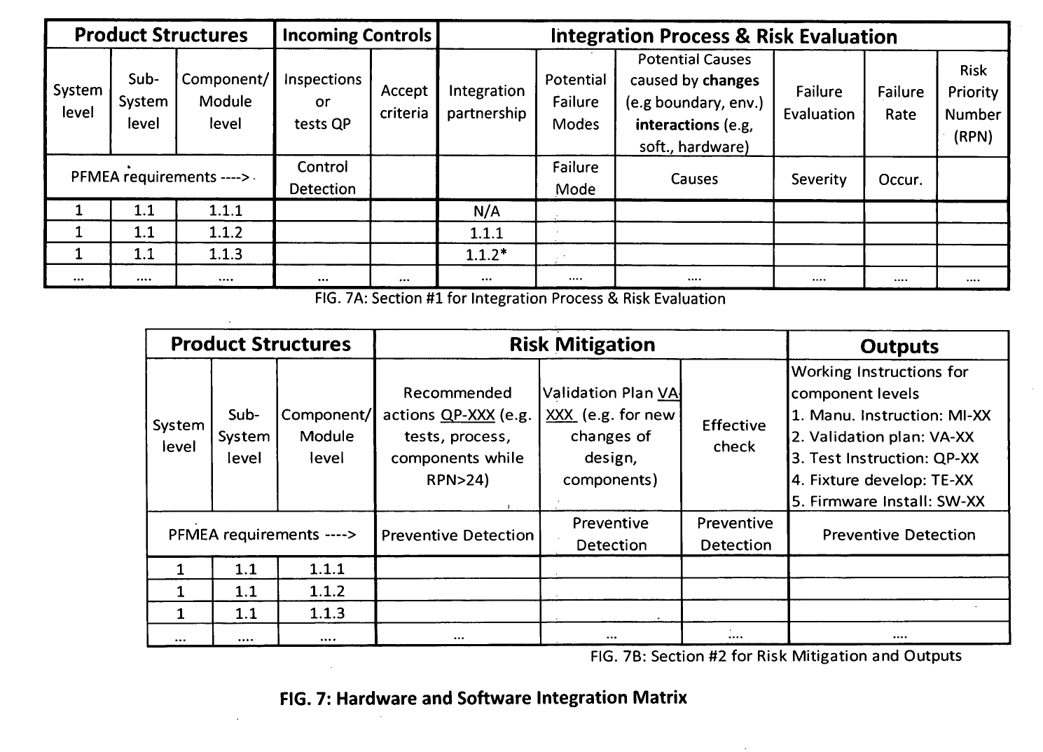

FIG. 8 (FMEA Frisbee) is a tool to determine an optimal FMEA tools for initiating mitigated actions once the risk levels of failure modes are unacceptable;

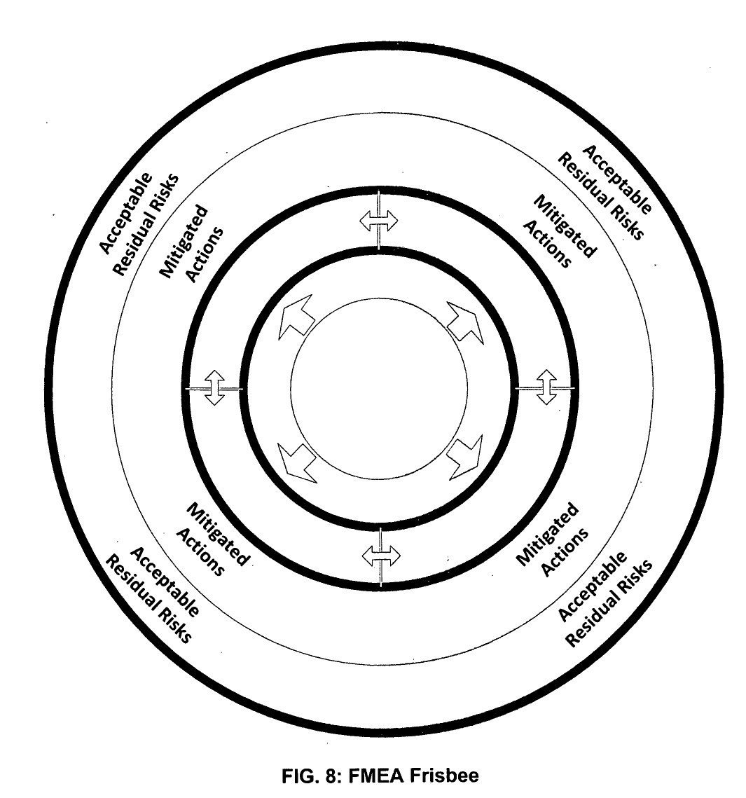

FIG. 9 is a FMEA template including components of Risk Analysis, Risk Evaluation, Risk Mitigation, Risk Residual, Risk/Benefit Analysis, and Risk Disposition;

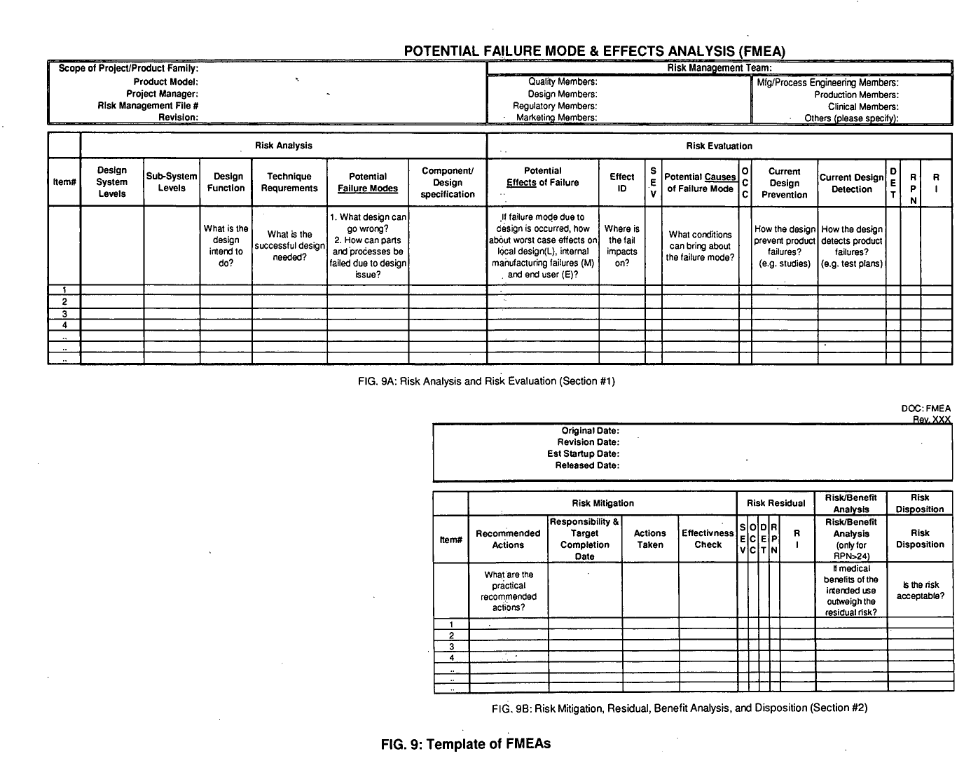

FIG. 10 is a spreadsheet to analyze the market requirements.

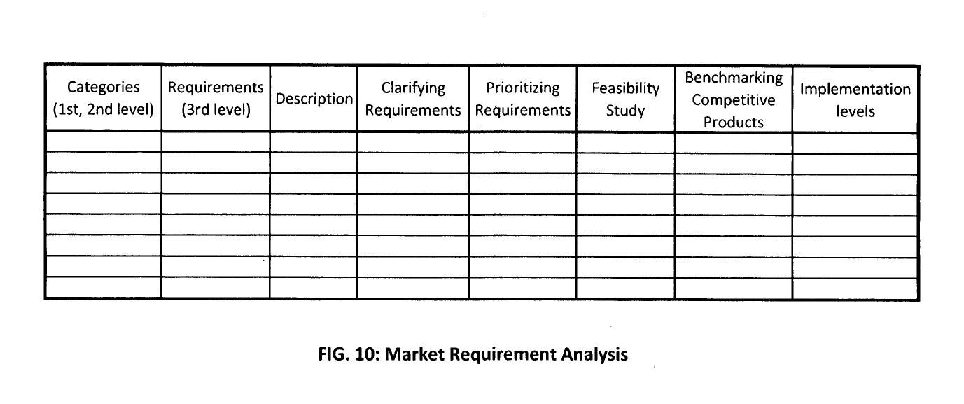

### DETAILED DESCRIPTION

Risk driven Product Development Process (RPDP) is to facilitate a new product development starting from surveying customer voices until supporting the product field service.

Product Planning Phase:

Once a project is initiated, Market department will reach out to all customers and understand what customers are expecting from the new product assisted by the survey spreadsheets. Customer requirements are normally qualitative and tend to be imprecise and ambiguous due to their linguistic origins. In most cases, requirements are negotiable and may conflict or are not independent with one another. RPDP has a step to clarify requirements and capture the genuine or “real” needs of customers. Meantime, the regulatory affair strategy, clinical study plan, risk management plan, and project schedule are developed.

The first step regarding RPDP application is to categorize customer requirements into multiple layers which can be developed by asking questions who are the users (1^{st} level)? what are the functions (2^{nd} level)?, and what are the detailed features (3^{rd} level)?. The second step is to prioritize the collected requirements by 1-5 ratings per critical levels. The level 5 requirements refer to product MUST achieved including products pass the safety tests, meet relevant standards (e.g. FDA clearance); the level 4 requirements refer to the product critical features which represent the direct functions for customers; the level 3 requirements refer to product functions which are used to support the level 4 requirements, or the product features would jump up customers to exciting; the level 2 requirements refer to product nice to have features; the level 1 requirements refer to product features which are not care. The third step is to explore potential requirement risks from the areas of operational, technical, and economic merits of the new products. The major technical feasibility assessment should to applied at early stages to better understand it can be delivered with the available technology, techniques, skills, and resources (human and financial). The fourth step is to benchmark customer requirements with the other competitive products and to make sure the new product is better than the previous generation products or those offered by competitors. It can be started from identifying products that are similar to yours and which can affect your market share. The approach is to go through each feature and make comparisons between the current product and the other products. The last step is to trace implementation levels for each requirement. Also it provides an entrance for introducing brand new requirements or requirement changes.

Product Design Phase:

Once clear customer requirements have been determined, the goals of product design phase are to efficient and effective turn the requirements into tangible design documentations such as drawings and material data.

Product structure model is a hierarchical decomposition of a product which uses to conduct design to follow the top-down method. Designers start from the conceptual designs (e.g. ideas, sketches) and detailed designs (e.g. features, layout, BOM, specifications) at the final product level, then breakdown the design at the system levels, subsystem levels, and component levels. For a software supported electromechanical device, both hardware (e.g. injection molding, mechanical, electrical, electronic parts) and software are designed along the top-down product structures. Particularly, the interaction between hardware and software at each level shall be considered at the same time.

Design FMEA is a structured analytical tool to identify and evaluate the potential failure modes at each design level. Within each item, the scopes of the technique requirements include intended use, specifications (e.g. dimensions, materials, tolerance), reliability index, and biological evaluation. The typical failure modes due to design errors include out of tolerance (e.g. when components are assembled in subsystem, they interfere each other or cannot fit), out of specification (e.g. the final systems do not perform the right functions), less reliability (e.g. improper reliability components or system architectures can result in a lower reliability on finished products), and wrong material selected. After risk evaluation, the mitigated actions may be to raise safety margins, increase material strengths, establish fail safe mechanisms, develop redundant systems, or provide protective mechanisms, etc if the potential risk is unacceptable.

The outputs of product design phase include Drawings, BOMs, Software codes, design verification reports, design validation reports, clinical feasibility studies reports, regulatory submissions.

Process Development Phase:

Once a product has design solutions, the goals of process development phase are to turn products from design protocols into high volume production by established one robust and optimized manufacturing process.

Since the product assembly model is a hierarchical composition of a product (opposite to product structure model), the integration sequences are starting from bottom component levels (e.g. parts, modules), then to sub-system levels, system levels, and finished product level. For a software supported electromechanical device, both hardware (e.g. injection molding, mechanical, electrical, electronic parts) and software are installed along the bottom-up product assembly. Particularly, the interaction between hardware and software at each level shall be planned at the same time.

Process FMEA is a structured analytical tool to identify and evaluate the potential failure modes at each development level. Within each item, the process description may be extracted by asking “what is the process supposed to do. The failure modes are the error states which caused by noise factors such as defective parts, failure of part assembly, or wrong product functions. After the risk evaluation, examples of mitigation actions may be go to redesign parts, install monitor or alarm device, setup quality methods and tests, increase process capability, or develop alternative means of operation if the potential risk is unacceptable.

The outputs of process development phase include process validation, manufacturing process diagrams and instructions, packaging, quality control and instructions, system integration and reliability test methods.

Product Service Phase:

Once the new product has been successfully launched to the market, the goals of product service phase are to establish service plans, post market assessment and surveillance, improve the sustainability performance, and launch product continue improvement and innovation.

Based on the determined reliability index (e.g. life cycle, MTTF, failure rate), manufacturer's warranty for material defects and service plan for product failure in general are generated. Based on the severity levels of failure modes from the Application FMEA, service methods are developed (e.g. service in-store by retailers, repair on-site by field engineers, ship back to manufacturer, replace the entire product, or product recalls). Based on the occurrence levels of failure modes from the Application FMEA, the trouble shoot manuals, reference manuals, and training manuals are built to deal with the high occurrence failure modes. Based on the detection levels of failure modes from the Application FMEA, product preventive maintenance schedules are established (e.g. replace new batteries). Based on the high RPN values from the Application FMEA, the issues for trouble shoot manuals are derived.

The Application FMEA also provides a place to address new hazards, customer complaints, objective evidences, and determinations of changes which are required by the post market surveillance from ISO 14971.

### REFERENCES

Morgan, J.; Liker, J. (2006). The Toyota Product Development System: Integrating People, Process and Technology. ISBN-10: 1563272822, Productivity Press, New York.

Oehmen, J.; Seering W. (2011). Risk-Driven Design Process: Balancing Efficiency with Resiliene in Product Design. The future of Design Methodology, Springer-Verlag London Limited, p 47-54.

Jaruzelski, Barry (2011). Next-Generation Product Development, Strategy+Business, Booz & Company.

I claim:

1. Risk driven Product Development Process (RPDP) consists of product plan, product design, process development, and product service. It has been mainly contributed by Design Control procedures (Planning, Design Input, Design Output, Design Review, Design Verification, Design Validation, Design Transfer, Design Changes) Process Development (Process Development, Process Validation, Process Transfer), Product Service (Product Launch, Post Market), and Risk Management tools (e.g. FMEA).

2. Risk driven Product Development Process (RPDP) is a systematic method to facilitate new product development projects as:
a) Within the product plan phase, the invention can lead to clarify the true customer requirements from imprecise and ambiguous surveys, prioritize the requirements per customer expectation, evaluate the feasibility per technical, operational, and economic merits, and benchmark with the competitive products (from internal or external) to position the markets, and review the requirement changes and trace the implementation by using the System FMEA;
b) Within the product design phase, the invention can lead to develop the regulatory submission, clinical studies, the product specifications, and software codes. The potential design risks are analyzed along the product top-down structures implemented in the Design FMEA or Software FMEA. The design changes are reviewed in each step to support the design improvements;
c) Within the process development phase, the invention can lead to develop the process validation, manufacturing flow diagrams, production stability metrics, packaging, and quality control matrix. The potential development risks are analyzed along the product bottom-up assembly structures implemented in the process FMEA or Supplier FMEA. The process changes are reviewed in each step for supporting the process optimization;
d) Within the product service phase, the invention can lead to develop regulatory certificates, service plans, post market assessment & surveillance, and product continue improvement. The potential field risks are analyzed in the Application FMEA.

3. According to claim 2, product development projects can not be moved to the next phase unless the potential risks in the current phase are acceptable (under tolerance) as defined by Risk Priority Number (RPN).

4. According to claim 2, mitigated actions are required if the current potential risks are unacceptable (over tolerance). The mitigated actions may be implemented in the local phase or upstream phases depending on the efficiency assisted by the FMEA Frisbee.

5. According to the System FMEA of claim 2, the severity scores of failure modes are dependent on effects of requirement failures, the detection scores of failure modes are based on technical feasibility studies, and the occurrence scores of failure modes are suggested by the competitive products.

6. According to the Design/Software FMEA of claim 2, product design activities are followed the top-down method (final product, systems, sub-systems, to components/modules). On the contrary, the failure modes are identified along the bottom-up method (components/modules, subsystems, systems, final product) including their interactions in each level.

7. According to the Process FMEA of claim 2, product assembly activities are followed the bottom-up method (components/modules, subsystems, systems, to final product). Meantime, failure modes are identified along the bottom-up method (components/modules, sub-systems, systems, to final product) including their interactions in each level.

8. According to claim 2, an Interaction Matrix provides a spreadsheet where product hardware and software systems are broken down into the part/module levels, and then analyzes the potential risks due to their interactions.

9. According to claim 2, an Integration Matrix provides a spreadsheet where product hardware (or software) systems are broken down into component (or module) levels, and then analyzes the potential risks on their integration activities.

10. According to claim 2, FMEAs template comprises by elements of Risk Analysis, Risk Evaluation, Risk Mitigation, Risk Residual, Risk/Benefit Analysis, and Risk Disposition.

11. A FMEAs Frisbee comprises System FMEA, Design FMEA, Process FMEA, and Application FMEA. For any unacceptable risks, mitigated actions are issued from a proper type of FMEAs based on the efficiency.
